(19) United States
(12) Patent Application Publication
(10) Pub. No.: US 2012/0084747 A1
(43) Pub. Date: Apr. 5, 2012

(54) PARTITIONED ITERATIVE CONVERGANCE PROGRAMMING MODEL

(75) Inventors: Srimat Chakradhar, Manalapan, NJ (US); Reza Farivar, Pasadena, CA (US); Anand Raghunathan, West Lafayette, IN (US)

(73) Assignee: NEC LABORATORIES AMERICA, INC., Princeton, NJ (US)

(21) Appl. No.: 13/235,988

(22) Filed: Sep. 19, 2011

Related U.S. Application Data
(60) Provisional application No. 61/483,910, filed on May 9, 2011.
(60) Provisional application No. 61/388,882, filed on Oct. 1, 2010.

(51) Int. Cl. G06F 9/44

(52) U.S. Cl. 717/104

(57) ABSTRACT

Methods and systems for iterative convergence include performing at least one global iteration. Each global iteration includes partitioning input data into multiple input data partitions according to an input data partitioning function, partitioning a model into multiple model partitions according to a model partitioning function, performing at least one local iteration using a processor to compute sub-problems formed from a model partition and an input data partition to produce multiple locally updated models, and combining the locally updated models from the at least one local iteration according to a model merging function to produce a merged model.

### RELATED APPLICATION INFORMATION

This application claims priority to provisional application Ser. No. 61/388,882 filed on Oct. 1, 2010, incorporated herein by reference and provisional application Ser. No. 61/483,910 filed on May 9, 2011, incorporated herein by reference.

### BACKGROUND

1. Technical Field

The present invention relates to parallel computing and, more particularly, to methods and systems for programming iterative convergence applications on a parallel computing platform.

2. Description of the Related Art

Writing correct and efficient parallel programs is difficult. In addition to specifying the application functionality, a programmer needs to be concerned about partitioning the workload into tasks that execute on each computer, assigning the tasks to specific computers, communicating data, and synchronizing the execution of the different tasks to correctly implement that functionality.

Cluster frameworks can be classified based on the level of abstraction they provide and the model of computation that they implement. Communication abstractions, such as the message passing interface (MPI), abstract the physical topology and details of the interconnection network from programmers, providing them with an application programming interface and library that handles the communication. However, other concerns such as partitioning and scheduling of the workload are left to the programmer.

High-level programming frameworks, such as MapReduce, greatly reduce the difficulty of programming parallel clusters by relieving the programmer of these concerns. A high-level programming model provides application programmers with a precise and simple interface to specify their applications, while an associated runtime framework executes the application on the parallel computing platform, handling details of partitioning, assigning tasks to specific computers, communication and synchronization between tasks, and fault tolerance.

However, implementations of iterative convergence algorithms on conventional high-level programming frameworks exploit parallelism only within each iteration and do not exploit the characteristics of the application across iterations. Because iterative algorithms use the results of previous iterations to process new iterations, the successive iterations cannot be parallelized through existing techniques. In addition, existing iterative algorithms maintain strict numerical equivalence between a serial implementation on a single computer and the parallel implementation, irrespective of whether such equivalence is necessary. Drawbacks of this approach include large communication traffic in order to update the model after each iteration, small granularity of tasks that increases overhead and repeated operations for managing tasks and reading input data.

### SUMMARY

An exemplary method for partitioned iterative convergence is shown that includes performing at least one global iteration. Each global iteration includes partitioning input data into a plurality of input data partitions according to an input data partitioning function; partitioning a model into a plurality of model partitions according to a model partitioning function; performing at least one local iteration using a processor to compute sub-problems formed from a model partition and an input data partition to produce a plurality of locally updated models; and combining the plurality of locally updated models from the at least one local iteration according to a model merging function to produce a merged model.

An exemplary system is shown that includes one or more global administrator nodes configured to partition a model and input data into sub-problems and a plurality of local nodes configured to perform iterative convergence computations. The global administrator nodes each include a processor configured to determine whether a merged model, formed from a plurality of locally updated models, satisfies a global convergence criterion and to initiate a new global iteration if the global convergence criterion is not satisfied. Each of the plurality of local nodes includes a processor configured to iterate a computation on a partitioned sub-problem until a local convergence criterion has been satisfied, producing a locally updated model.

An exemplary method for partitioned iterative convergence is shown that includes performing at least one global iteration. Each global iteration includes partitioning input data into a plurality of interdependent input data partitions according to an input data partitioning function; partitioning a model into a plurality of model partitions according to a model partitioning function; performing a plurality of parallel local iterations; combining the plurality of locally updated models from the plurality of parallel local iterations according to a model merging function to produce a merged model; and determining whether to perform a subsequent global iteration based on a global convergence criterion that considers the merged model. Each local iteration includes computing sub-problems formed from a model partition and an input data partition using a processor to produce a locally updated model; and determining whether to perform a subsequent local iteration based on a local convergence criterion that considers a locally updated model.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method of partitioned iterative convergence according to the present principles;

FIG. 2 is a diagram comparing the complexity of iterated MapReduce processes as compared to partitioned iterative convergence according to the present principles; and

FIG. 3 is a diagram of a system configured to perform partitioned iterative convergence computations according to the present principles.

### DETAILED DESCRIPTION OF PREFERRED EMBODIMENTS

Iterative convergence algorithms are extensively used in application domains such as recognition, mining and synthesis, data analytics, web search, and social networks. These algorithms typically build a model from a large corpus of unstructured data. The model is computed by generating a sequence of increasingly accurate solutions, starting from an initial guess, until a convergence criterion is satisfied. The process of generating a more accurate solution is referred to as refinement of the model and may involve a parallel computation over the input data.

The present principles introduce a new programming model and associated runtime framework for implementing iterative convergence algorithms on parallel clusters. The present principles are better suited to iterative convergence workloads than the previously existing techniques and achieve higher performance than frameworks such as MapReduce and Hadoop™.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

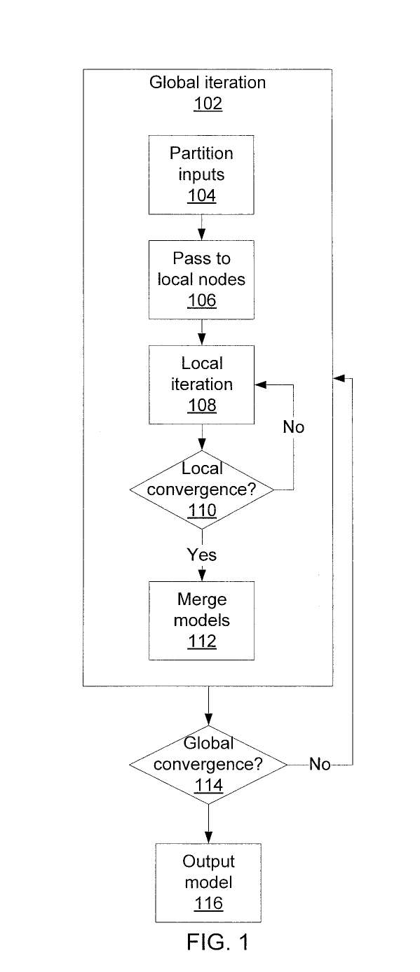

Referring now to the drawings in which like numerals represent the same or similar elements and initially to FIG. 1, an iterative convergence programming model is shown according to the present principles. Execution is organized into global iterations 102 and local iterations 108. A local iteration 108 executes on a single computing device. This could include a single computer in a larger cluster for example, or it could represent a single processing element in a multi-core processor. It is contemplated that any suitable processor or processing module could be employed according to the present principles, and the examples cited herein are not intended to be exhaustive.

Global iteration 102 partitions 104 input data into partitioned models to that are sent to local nodes. The partitioning 104 employs an application-specific partitioning function to break the problem into sub-problems. Block 106 passes these sub-problems, including a partitioned model and partitioned input data, to the local nodes, allowing the node to perform a local iteration 108 and produce a locally updated model. Each local iteration 108 may be expressed using existing parallelization techniques, such as MapReduce, to exploit intra-iteration parallelization. The node then tests the partial model to determine whether the node has reached local convergence 110 using a local convergence criterion. If not, the node continues to iterate 108 until reaching local convergence, using the partial model from a previous iteration 108 as input for the subsequent iteration 108. Once local convergence 110 has been reached, block 112 merges the models from the partitioned local nodes using an application-specific merging function to complete the global iteration 102 and produce a single output model. Block 114 determines whether the global iteration 102 has satisfied a global convergence criterion. If not, a new global iteration 102 begins, with the partitioning step 104 being applied to the merged model from the previous iteration's merge block 112. If the global convergence criterion has been met, then the finished model is output at block 116.

Compared to conventional models, such as MapReduce, the present principles provide distinct advantages. For example, when executing an iterative convergence algorithm, each MapReduce job deals with work only within a particular iteration. On the other hand, the present principles aggregate computations from multiple iterations 102, since multiple local iterations 108 may be executed. Run-time overhead and global communications are decreased as a result. Furthermore, the amount of communication between Map and Reduce tasks in any given iteration is usually proportional to the size of the input data. Employing the present principles, global communication is proportional instead to the size of the updated models 112 produced by local iterations 108 when the models 112 are merged once per global iteration. The updated models 112 are significantly smaller than the entire body of input data, such that the embodiments of the present principles communicate much less data during operation. Not only is the size of the data reduced, but the frequency of data communication is reduced as well.

The reduced communication between computers results in a potential increase in the computation performed in local iterations 108. In other words, the total work performed by the parallel implementation may be larger than a sequential implementation. However, this increase is usually small and is outweighed by the large improvements in efficiency produced by parallelization, resulting in a net improvement in execution time on parallel clusters compared to conventional programming models.

In order to accomplish these goals, the present principles do not maintain strict numerical equivalence between sequential and parallel implementations of a given iterative convergence algorithm. In other words, it is permissible for the parallel implementation to give different results when compared to the sequential implementation. This is acceptable because iterative convergence algorithms often represent statistical computations where numerical equivalence is not necessary, such as when there is no single “correct” result.

For example, applications in the fields of recognition, mining, and synthesis; data analytics; unstructured data analysis; web search; and social networking frequently employ large, noisy, and redundant input data sets utilize statistical or probabilistic computations, and inherently reflect user expectations of less-than-perfect results. This “forgiving nature” of the applications implies that, unlike other classes of applications, such as financial transactions, there is flexibility in the numerical accuracy of the solution as well as in the specific methods that may be employed to produce acceptable solutions. By artfully selecting an application-specific partitioning function to use in partitioning 104 and model merging 112, it is possible to overcome perceived quality of solution and convergence problems.

It is helpful to understand how the present principles differ from MapReduce and other parallelization programming models. The pseudocode below shows an abstract description of an iterative convergence algorithm using MapReduce. The map function typically uses each element of the input data together with the model to compute intermediate data, said data being represented by key-value pairs in accordance with the semantics of MapReduce. The reduce function uses the intermediate data to compute an updated model.

IC(input data d, model m) {

do {

m = reduce(map(d, m));

} until converged(m)

} //A template for MapReduce

The following pseudocode shows the k-means clustering algorithm implemented using MapReduce. The input data for k-means includes points in a multi-dimensional space and the model includes cluster centroids. The map function performs distance computations between a point and all centroids and then computes the centroid that is closest to a point. The intermediate data includes key-value pairs, where the key is the centroid and the value is the point associated with it. The reduce function performs a dimension-wise average of all points associated with a centroid to compute the updated version of the centroid.

d = points
m = centroids
IC(input data d, model m) {

do {

map: for each point in d

emit (key: closest centroid; value: point)

reduce: for each key

m[key] = average(all values for key)

} until converged(m)

} // An implementation of k-means using MapReduce

The above implementation of k-means is far from optimal in terms of performance. In general, the ease of programming with MapReduce has led to its use even in problems where it is not an idea fit, either in terms of functional semantics or of performance. MapReduce suffers from repeated initialization, where each iteration of the loop is a separate MapReduce job—initialization and cleanup are performed at each iteration. Each MapReduce job reads its input data from a cluster's file system. Furthermore, the intermediate data in each MapReduce job is communicated across the cluster interconnect due to the all-to-all nature of the communication. Managing a large volume of intermediate data often has a profound impact on application performance. In addition, because the model is updated in each iteration, it is synchronized across the cluster as well. Model size may be large in itself, thereby placing another communication burden due to model updates.

The partitioned iterative convergence (PIC) pseudocode shown below addresses the above problems. PIC partitions 104 input data and the model to create smaller sub-problems, with each sub-problem being addressed using independent iterative-convergence computations 108. The models generated by the partitioned computations 108 are merged 112 to create a unified model on which a convergence test 114 is performed. To capture information across sub-problems, this process is repeated with the new unified model as the starting point until a global convergence criterion is satisfied 114.

Partitioned_IC(input data d, model m) {

do {

partition(d,m); //creates z partitions
for each partition p_i {

IC(d_i, m_i)

}
m = merge(m_1, m_2, ... , m_z)

} until converged(m)

} // A template for PIC

The partitions are executed independently, even though they may have inter-partition dependencies. Therefore, with respect to a sequential implementation, numerical equivalence is not maintained. Re-casting iterative convergence computations into local iterations 108 (executed within a partition) and global iterations 102 (executed across partitions) creates a coarse-grained, loosely coupled computation at the cost of potentially increasing the total work performed. The volume of data communicated between different partitions is much smaller than the communication within a partition. The localization of communication can be exploited by executing each partition on a single cluster node or a small set of tightly coupled cluster nodes, leading to a substantial reduction in traffic.

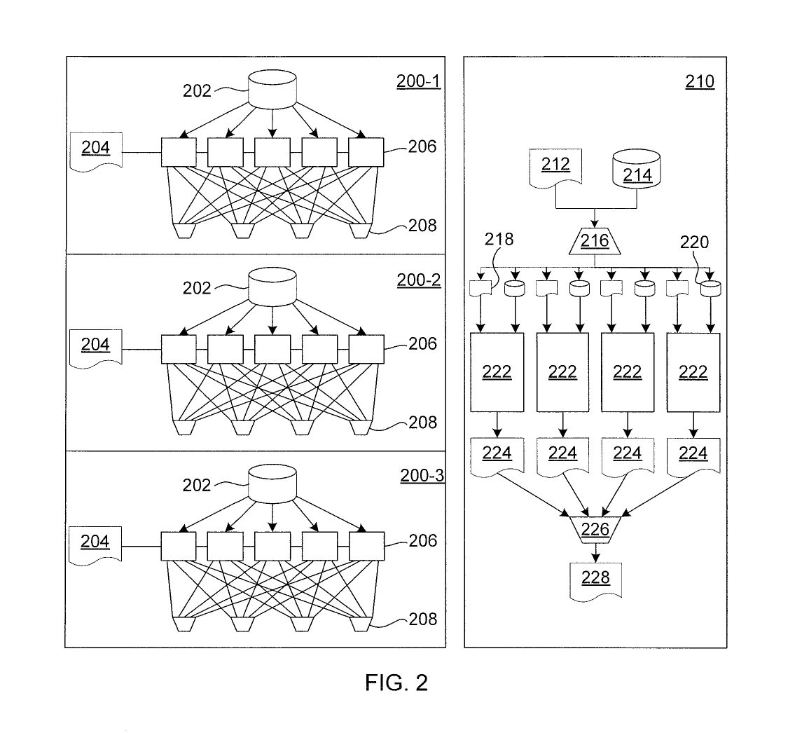

Referring now to FIG. 2, a graphical comparison of iterative convergence implemented with MapReduce 200 and PIC 210 is shown. The MapReduce iterations 200 take input data 202 and model 204 and process the information at map blocks 206. The information is then condensed in the reduce step 208, and the entire iteration 200 is repeated until reaching convergence. At each step 200, the input data is sent to all of the nodes at 206 and then cross-sent for reduction at 208, resulting in a large amount of wasted communication. In contrast, PIC global iteration 210 takes input model 212 and input data 214 and partitions them at partitioner 216, producing partitioned models 218 and partitioned inputs 220. The partitioned models 218 and inputs 220 are passed to a local node 222 for iterative processing (see block 108 in FIG. 1) until local convergence (block 110 in FIG. 1) is reached. The local notes 222 produce output models 224 which are merged at a merging module 226 to produce an updated model 228. The PIC iterations 210 need much less inter-node communication, making them more efficient in cluster implementations and when working with applications that are of a forgiving nature.

A significant difference between iterative convergence with MapReduce 200 and PIC 210 is the dimension along which parallelism is exploited. Conventional implementations can only exploit parallelism within each iteration (e.g., the map step 206), which may be fine-grained and lead to high volumes of interconnect traffic due to the MapReduce intermediate data and model updates. PIC 210 introduces a new degree of parallelism—the relatively coarse-grained, loosely coupled parallelism across partitions. Each partition is executed on a single node or a small set of tightly coupled nodes 222, drastically reducing global cluster interconnect traffic.

In addition, a generic PIC template provides the programmer with several mechanisms to control both performance and the degree to which the forgiving nature of the application may be exploited. For example, the programmer may specify the number of partitions, the choice of partition and merge functions, and the convergence criteria used for global and local iterations 102 and 108. For example, a larger number of partitions results in more independent sub-problems of smaller size, but may also increase the number of global iterations that need to be executed until convergence is reached. More complex partition and merge functions may result in sub-problems that have fewer dependencies, thereby facilitating faster convergence at the cost of increased computational complexity at the partition and merge stages.

Porting a conventional MapReduce implementation into a PIC implementation includes specifying the partition 216 and merge 226 functions. The partition function 216 creates sub-problems from the input model 212 and data set 214. The specific choice of this function 216 is application dependent. In some problems, it is appropriate to break up both the input data and the model (for example, when using a PageRank algorithm); in other cases it is more appropriate to break up the input data but create multiple copies of the model (for example when using a k-means algorithm). The partitions may be strictly disjoint or may contain some overlap in order to facilitate faster convergence. The complexity of the partition function may range from simple approaches such as randomly breaking up the input data and/or model, to more sophisticated partitioning schemes that attempt to reduce inter-partition dependencies. Any appropriate partition function may be selected in accordance with the needs of a particular problem.

In general, two factors are considered when specifying the partition function 216. First, the sub-problems that are created should be of roughly equal size such that the computations on them are balanced across nodes 222. Second, the partition function should preferably create sub-problems such that dependencies between the partitions are minimal. While the pseudocode above implies that the partition function is executed at each global iteration 210, the input data 214 remains unchanged through the iterations and is partitioned only during the first iteration. The updated model 228 is partitioned in the next global iteration 210.

The merge function 226 takes the models 224 produced by different sub-problems 222 and creates a unified updated model 228. The merge function 226 depends on the application semantics as well as the choice of partition function 216. For example, if the partition function 216 divides the model 212 into disjoint parts that are updated by the sub-problems 222, the merge function 228 may simply piece the output models 224 back together. If copies of the model 212 were created, they may be put through an averaging function to construct the updated model 228. In many problems, the merge function 226 may be used to perform additional computations that compensate for the effect of ignoring inter-partition dependencies. As with the partition function, any appropriate merge function may be used in accordance with the needs of the problem and with the selected partition function.

For ease of development, PIC may be implemented as a library that operates within or on top of existing MapReduce implementations, such as Hadoop™, that may be used to specify an iterative convergence computation. The PIC library may include a set of abstract classes that a programmer may specialize to create the program. There are two major classes that define global and local iterations. The global class may implement member functions such as an input partitioner 104, which partitions input data into sub-problems, a model merge 112, which merges local models for subsequent global iterations, and a global convergence criterion 114 which decides whether additional global iterations are necessary. The local computations class may implement member functions such as the map and reduce computations that are performed locally on a sub-problem and the local convergence criterion, which is run after each local iteration to decide when to finish local iterations.

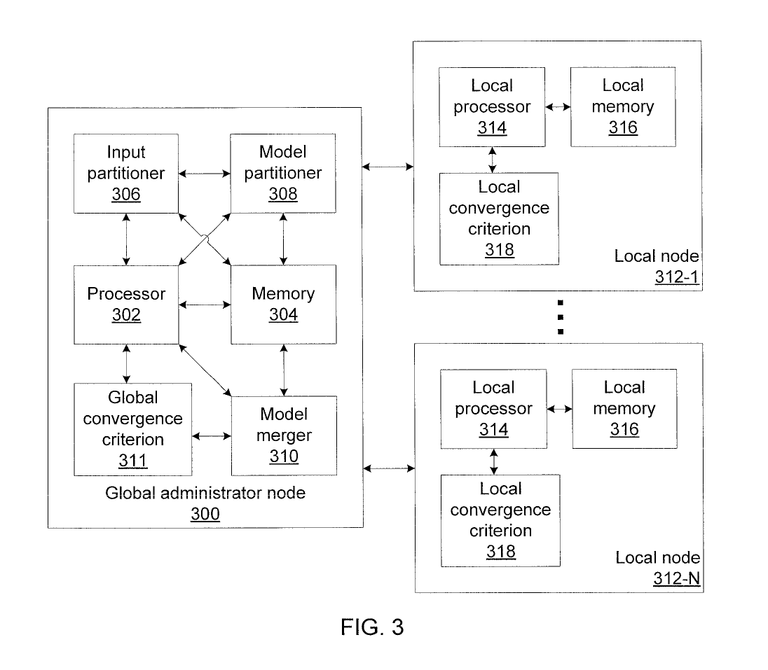

Referring now to FIG. 3, a system for PIC is shown. A global administrator node 300 communicates with N local nodes 312 and parcels out sub-problems to the local nodes. The global node 300 includes a processor 302 and a memory 304, while local nodes 312 include a local processor 314 and a local memory 316. Each or all of the modules internal to the global and local nodes 300 and 312 may include or communicate with said processors and memories in performing their respective tasks. The global node 300 executes global iterations and the local nodes 312 execute local iterations as described above in FIG. 1. It should be noted that the global administrator node 300 does not have to be wholly separate and may function as a local node 312 after partitioning has been performed.

Global node 300 includes an input partitioner module 306 and a model partitioner module 308. These partitioner modules may be implemented separately or as a part of a single module. Model partitioner module 308 is used in each global iteration, whereas input partitioner 306 is used only during the first global iteration, as the input data does not change between global iterations. The partitioned input and models are then sent to local nodes 312 for processing.

Each local node 312-2 uses its local processor 314 and memory 316 to perform local iterations on its respective sub-problem. Local nodes 312 will continue to perform local iterations, generating locally updated models, until the local convergence criterion 318 has been met. At that point, local node 312 sends its locally updated model back to global administrator node 300.

Global administrator 300 collects the locally updated models and combines them in model merger 310 to produce a merged model. Global convergence criterion 311 tests the merged model to determine whether further global iterations are needed. If so, processor 302 signals model partitioner 308 to partition the merged model and sends the newly partitioned sub-problems to local nodes 312 for further local processing. Upon satisfaction of global convergence criterion 311, global administrator node 300 outputs the merged model as the output of the PIC computation.

The present principles can perhaps be best understood through an example application. The k-means algorithm clustering algorithm is an example of an iterative convergence algorithm designed to create a representative model of k centroids from a data set represented by a body of points in an n-dimensional Cartesian space. Pseudocode for a pure MapReduce implementation of k-means is described above. Below is pseudocode for implementing k-means in a PIC programming model. The iterative convergence algorithm of the MapReduce implementation is used within the PIC template to solve clustering sub-problems. The partition function divides the problem into sub-problems and the merge function combines the models from each sub-problem.

Partitioned_IC(input data d, model m) {

do {

//partition input data points, copy m to each partition
p_1 ... p_z = partition (d, m)
map: for each partition p_i {

IC(d_i, m_i)
emit (key=1; value=m_i)

}
//Average closest centroids from z sub-problems as new centroid
reduce: m=merge(values m_1 ... m_z for key = 1)

} until converged(m)

} //k-means implemented in PIC

Random partitioning is a useful mechanism for partitioning 114 the input data. Minimal information dependency between sub-problems is achieved due to the nature of k-means and its dependence on Cartesian distance. When incorporating centroids from other sub-problems in the assignment phase of k-means in another sub-problem, only those centroids close to the current centroid will be assigned. Therefore, to compute each centroid one needs only a small fraction of information from other sub-problems.

Once the data is divided, each node 312 can work independently on that dataset to find k centroids with as many local iterations as are required to achieve a certain accuracy threshold. The sub-model 224 computed from each sub-problem 222 is a set of k centroids. The merge function 226 finds the closest centroids from all the sub-problems and computes their average to compute a final set of centroids 228. The convergence criterion 110 stops global iterations 102 when the centroids' average movement drops below a threshold.

In tests of data sets ranging from 500,000 to 500,000,000 data points, a PIC implementation showed improvements in speed by a factor of six to ten over a vanilla MapReduce implementation.

Having described preferred embodiments of a system and method for partitioned iterative convergence (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for partitioned iterative convergence comprising:
performing at least one global iteration, said global iteration comprising:
partitioning input data into a plurality of input data partitions according to an input data partitioning function;
partitioning a model into a plurality of model partitions according to a model partitioning function;
performing at least one local iteration using a processor to compute sub-problems formed from a model partition and an input data partition to produce a plurality of locally updated models; and
combining the plurality of locally updated models from the at least one local iteration according to a model merging function to produce a merged model.

2. The method of claim 1, wherein performing at least one global iteration includes determining whether to perform a subsequent local iteration based on a local convergence criterion that considers a locally updated model.

3. The method of claim 1, further comprising determining whether to perform a subsequent global iteration based on a global convergence criterion that considers the merged model.

4. The method of claim 1, wherein there are inter-partition dependencies present between the sub-problems.

5. The method of claim 1, wherein the model partitioning function subdivides a model and the model merging function concatenates a plurality of models.

6. The method of claim 1, wherein the model partitioning function creates copies of a model and the model merging function averages a plurality of models.

7. The method of claim 1, wherein performing a local iteration includes executing a MapReduce process on the sub-problem.

8. The method of claim 1, wherein the partitioning steps are performed only once.

9. A computer readable storage medium comprising a computer readable program, wherein the computer readable program when executed on a computer causes the computer to perform the steps of claim 1.

10. A system, comprising:
one or more global administrator nodes configured to partition a model and input data into sub-problems, comprising:
a processor configured to determine whether a merged model, formed from a plurality of locally updated models, satisfies a global convergence criterion and to initiate a new global iteration if the global convergence criterion is not satisfied; and
a plurality of local nodes configured to perform iterative convergence computations, comprising:
a processor configured to iterate a computation on a partitioned sub-problem until a local convergence criterion has been satisfied, producing a locally updated model.

11. The system of claim 10, wherein there are inter-partition dependencies present between the sub-problems.

12. The system of claim 10, wherein the one or more global administrator nodes further comprise a partitioning module configured to partition input data and a model into sub-problems according to a partitioning function.

13. The system of claim 12, wherein the one or more global administrator nodes further comprise a model merge module configured to accept a plurality of locally updated models and produce a merged model according to a merge function.

14. The system of claim 13, wherein the partitioning function subdivides a model and the merge function concatenates a plurality of models.

15. The system of claim 13, wherein the partitioning function creates copies of a model and the merge function averages a plurality of models.

16. The system of claim 10, wherein the processors of the local nodes are further configured to executing a MapReduce process on the partitioned sub-problem.

17. The system of claim 10, wherein each local node processes a different sub-problem.

18. A method for partitioned iterative convergence comprising:
performing at least one global iteration, said global iteration comprising:
partitioning input data into a plurality of interdependent input data partitions according to an input data partitioning function;
partitioning a model into a plurality of model partitions according to a model partitioning function;
performing a plurality of parallel local iterations, comprising
computing a sub-problems formed from a model partition and an input data partition using a processor to produce a locally updated model; and
determining whether to perform a subsequent local iteration based on a local convergence criterion that considers a locally updated model;
combining the plurality of locally updated models from the plurality of parallel local iterations according to a model merging function to produce a merged model; and
determining whether to perform a subsequent global iteration based on a global convergence criterion that considers the merged model.
